(19) United States
(12) Patent Application Publication
(10) Pub. No.: US 2024/0403644 A1
(43) Pub. Date: Dec. 5, 2024

(54) OPTIMIZING DEEP NEURAL NETWORK MODELS BASED ON SPARSIFICATION AND QUANTIZATION

(71) Applicant: Microsoft Technology Licensing, LLC, Redmond, WA (US)

(72) Inventors: Rasoul SHAFIPOUR, Bellevue, WA (US); Bita DARVISH ROUHANI, Bellevue, WA (US); Eric Sen CHUNG, Woodinville, WA (US); Douglas C. BURGER, Bellevue, WA (US)

(21) Appl. No.: 18/326,931

(22) Filed: May 31, 2023

(51) Int. Cl. G06N 3/082; G06N 3/0495

(52) U.S. Cl. CPC G06N 3/082; G06N 3/0495

(57) ABSTRACT

Embodiments of the present disclosure include systems and methods for optimizing deep neural network models based on sparsification and quantization. A device may identify a layer in a plurality of layers included in a neural network model, each layer in the plurality of layers comprising a plurality of weight values. The device may select a weight value from the plurality of weight values in the layer. The device may remove the weight value from the plurality of weight values in the layer to produce a modified version of the layer. The device may update remaining weight values in the plurality of weight values in the modified version of the layer, wherein removing the weight value and updating the remaining weight values provides greater compression of the neural network model and reduces loss of accuracy of the neural network model.

### BACKGROUND

The present disclosure relates to machine learning models. More particularly, the present disclosure relates to optimizing deep neural network models based on sparsification and quantization.

A neural network model is a machine learning model used for a variety of different applications (e.g., image classification, computer vision, natural language processing, speech recognition, writing recognition, etc.). A neural network model may be trained for a particular purpose by running datasets through it, comparing results from the neural network model to known results, and updating the neural network model based on the differences.

### BRIEF DESCRIPTION OF THE DRAWINGS

Various embodiments of the present disclosure are illustrated by way of example and not limitation in the figures of the accompanying drawings.

FIG. 1 illustrates a system for optimizing deep neural network models based on sparsification and quantization according to some embodiments.

FIG. 2 illustrates an example deep neural network (DNN) model according to some embodiments.

FIG. 3 illustrates the weight values of a layer in the deep neural network model illustrated in FIG. 2 according to some embodiments.

FIGS. 4A and 4B illustrate an example of sparsifying the weight values illustrated in FIG. 3 according to some embodiments.

FIGS. 5A and 5B illustrate another example of sparsifying the weight values illustrated in FIG. 3 according to some embodiments.

FIG. 6 illustrates the weight values illustrated in FIG. 3 after sparsification is completed according to some embodiments.

FIGS. 7A-7D illustrate an example of quantizing the weight values illustrated in FIG. 3 according to some embodiments.

FIG. 8 illustrates the weight values illustrated in FIG. 3 after quantization is completed according to some embodiments.

FIG. 9 illustrates a process for optimizing a deep neural network model based on sparsification according to some embodiments.

FIG. 10 depicts a simplified block diagram of an example computer system according to some embodiments.

FIG. 11 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described herein are techniques for optimizing deep neural network models based on sparsification and quantization. In some embodiments, a neural network model optimizer is configured to optimize deep neural network models. A neural network model can include an input layer, a set of hidden layers, and an output layer. Each of these layers may include one or more nodes that are connected to one or more other nodes in the neural network model. Each connection can have a weight value associated with it. When a neural network model is trained, its weight values are repeatedly updated so the neural network model can learn to produce desired set of outputs for a given set of inputs. After a neural network model is trained and can be used for inference, the neural network model optimizer can optimize the weight values of the neural network model. In some embodiments, the neural network model optimizer employs layer by layer approach to optimize the weight values of a neural network model.

The neural network model optimizer may use different techniques to optimize (e.g., memory, compute, communication, etc.) neural network models. In some cases, the neural network model optimizer uses a sparsification technique. For example, for each layer in a neural network model, neural network model optimizer analyzes the weight values in the layer to select a particular weight value from the weight values. Next, the neural network model optimizer removes the selected weight value from the weight values of the layer to form a modified version of the layer. Then, neural network model optimizer updates the remaining weight values of the layer in a manner that minimizes the error between outputs that the unmodified layer generates (i.e., without the weight value removed) and outputs that the modified layer generates, given the same inputs. The neural network model optimizer repeats this process to continue removing weight values from the layer until a defined set of conditions are satisfied.

In other cases, the neural network model optimizer utilizes a quantization technique to optimize neural network models. For instance, for each layer in a neural network model, neural network model optimizer selects a block of weight values from the weight values in the layer. The neural network model optimizer then quantizes the weight values in the block that minimizes the error between outputs that the unmodified layer generates (i.e., without the weight values quantized) and outputs that the modified layer generates, given the same inputs. Next, the neural network model optimizer repeats this process to continue quantizing blocks of weight values from the layer until a defined set of conditions are satisfied.

The techniques described in the present application provide a number of benefits and advantages over conventional methods for optimizing deep neural network models. For example, optimizing neural network models using the aforementioned techniques provides greater compression of the neural network model and reduces any loss of accuracy of the neural network model as a result of modifying the layers. Greater compression of neural network models reduces the amount of resources (e.g., storage, memory, bandwidth, processing, etc.) needed to use the neural network model for inferencing.

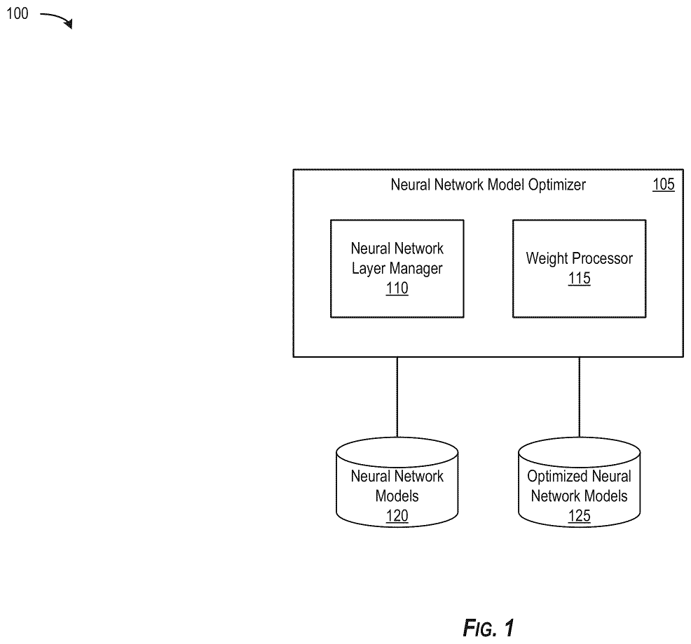

FIG. 1 illustrates a system 100 for optimizing deep neural network models based on sparsification and quantization according to some embodiments. In some embodiments, system 100 may be implemented by a computing device, a computing system, etc. As shown, system 100 includes neural network model optimizer 105, neural network models storage 120, and optimized neural network models storage 125. Neural network models storage 120 is configured to store unoptimized neural network models (e.g., untrained neural network models that need to be trained, trained neural network models that are to be used for inferencing, etc.). Optimized neural network models storage 125 stores optimized neural network models (e.g., neural network models optimized by neural network model optimizer 105).

Neural network model optimizer 105 is responsible for optimizing neural network models. As illustrated in FIG. 1, neural network model optimizer 105 includes neural network layer manager 110 and weight processor 115. To optimize a neural network model, neural network model optimizer 105 accesses neural network models storage 120 to retrieve a neural network model and sends it to neural network layer manager 110 for processing. Neural network model optimizer 105 may receive the optimized neural network model from neural network layer manager 110 after neural network layer manager 110 is finished processing the neural network model.

Neural network layer manager 110 is responsible for managing the processing of layers of neural network models. For instance, neural network layer manager 110 can receive a neural network model from neural network model optimizer 105 to process. In response, neural network layer manager 110 identifies a layer in the neural network model and sends weight processor 115 the neural network model along with a request to process the weight values in the identified layer. When neural network layer manager 110 receives the neural network model back from weight processor 115, neural network layer manager 110 continues identifying remaining layers in the neural network model for weight processor 115 to process until all the layers have been processed. Once neural network layer manager 110 finishes processing the neural network model, neural network layer manager 110 stores it in optimized neural network models storage 125.

Weight processor 115 handles the processing of weight values in neural network models. For example, weight processor 115 can receive from neural network layer manager 110 a neural network model and a request to process the weight values in a layer of the neural network model. In response to the request, weight processor 115 uses an optimization technique to modify the weight values in the layer of the neural network model. In cases where a sparsification technique is used, weight processor 115 selects a weight value from the weight values in the layer of the neural network model, removes the selected weight value from the layer, and updates the remaining weight values.

Different embodiments may use different methods for selecting a weight value from the weight values in a layer of a neural network model and updating the remaining weight values. For example, in some embodiments, weight processor 115 uses a Hessian based method to select a weight value and update the remaining weight values. In some such embodiments, weight processor 115 uses the following equation (1) to calculate an approximate loss value resulted from removing a weight value and updating the remaining weight values:

$${L}_{q} = \frac{1}{2} \frac{{w}_{q}^{2}}{{[ {H}^{- 1} ]}_{qq}}$$

where q is the index of a weight value w, L_{q} is a loss value of the weight value, [H⁻¹]_{qq} is the q^{th} diagonal entry of H⁻¹, and His a Hessian value determined with the following equation (2):

H=XX^{T}

where X is a matrix of outputs from the activation functions from the previous adjacent layer in the neural network. Equation (1) represents the amount of deviation between the output generated from the layer with a weight value removed and the original output generated by the layer. In some embodiments, a Hessian value may be determined for a defined operation and the loss incurred from deviating from the defined operation. In some embodiments where the defined operation is a linear layer in a neural network model (e.g., y=x^{T} w, where w are the weight values in a layer in a neural network model, x^{T} is the transpose of a matrix of outputs from the activation functions from the previous adjacent layer in the neural network, and y is the output of the product between x^{T} and w), minimizing the mean-squared loss yields the Hessian value in equation (2).

After calculating a loss value, L_{q}, for each weight value in the layer of the neural network, weight processor 115 selects the weight value that produces the lowest loss value based on equation (1). Then, weight processor 115 removes the selected weight value from the layer in the neural network model. After removing a weight value from the layer of the neural network model, weight processor 115 updates the remaining weight values in the layer. In some embodiments that employ a Hessian based method, weight processor 115 updates the remaining weight values in a layer of a neural network model using the following equation (3):

$$δ w = \frac{- {w}_{q}}{{[ {H}^{- 1} ]}_{qq}} {H}^{- 1} {e}_{q}$$

where q is the index of a weight value w, δw is a value added to the weight value w (e.g., the update), q is the index of a weight value w, [H⁻¹]_{qq} is the q^{th} diagonal entry of H⁻¹, H is a Hessian value determined using the equation (2) provided above, and e_{q} is a basis vector with 1 in the q^{th} index and 0 in all other indices. In some instances, weight processor 115 updates the remaining weight values in the layer of the neural network model in a manner that directly minimizes the error determined using the following equation (4):

$$E = \frac{1}{2} {‖ {y}^{T} - {w}^{T} x ‖}_{2}^{2}$$

where E is an error value, w is a matrix of weight values in a layer, x is a matrix of outputs of the activation functions generated by the previous adjacent layer, and y is the output of the layer. Equation (4) is effectively one half of the square of the Euclidean norm of the difference between the output of the layer and the product of the matrix of weight values in the layer and the matrix of outputs of the activation functions generated by the previous adjacent layer.

In some embodiments, weight processor 115 uses a Hessian and gradient based method to select a weight value and update the remaining weight values. In some such embodiments, weight processor 115 uses the following equation (5) to calculate a loss value for a weight value:

$${L}_{q} = {g}^{T} δ {w}^{*} + \frac{1}{2} δ {w}^{* T} H δ {w}^{*}$$

where g is a gradient, L_{q} is a loss value of a weight value, and H is a Hessian value determined with equation (2) mentioned above. As mentioned above, in some embodiments, a Hessian value may be determined for a defined operation and the loss incurred from deviating from the defined operation. Similarly, a gradient value can also be determined for a defined operation and the loss incurred from deviating from the defined operation. Here, the defined operation is a linear layer in a neural network model. As such, g may be determined using the following equation (6):

$$g = - x ( y - {x}^{T} w )$$

where w is a matrix of weight values in a layer, x is a matrix of outputs of the activation functions generated by the previous layer, and y is the output of the layer. δw* is a value added to the weight value w (e.g., the update), which can be calculated using the following equation (7):

$$δ {w}^{*} = \frac{{e}_{q}^{T} {H}^{- 1} g - {w}_{q}}{{[ {H}^{- 1} ]}_{qq}} {H}^{- 1} {e}_{q} - {H}^{- 1} g$$

where H is a Hessian value determined with equation (2) described above, g is a gradient determined with equation (6), q is the index of a weight value w, [H⁻¹] qq is the q^{th} diagonal entry of H⁻¹, and e_{q} is a basis vector with 1 in the q^{th} index and 0 in all other indices. After calculating a loss value, L_{q}, for each weight value in the layer of the neural network, weight processor 115 selects the weight value that generates the lowest loss value based on equation (5) and removes the selected weight value from the layer in the neural network model.

Upon removing a weight value from the layer of the neural network model, weight processor 115 updates the remaining weight values in the layer. In some embodiments that utilize a Hessian and gradient based method, weight processor 115 updates the remaining weight values in a layer of a neural network model using equation (7). In some cases, weight processor 115 updates the remaining weight values in the layer of the neural network model in a manner that minimizes the error determined using equation (4) provided above.

Once weight processor 115 updates the remaining weight values in the layer of the neural network model, weight processor 115 repeats the same process on the layer (i.e., identifying a weight value, removing the weight value, and updating the remaining weight values) until a defined set of conditions are satisfied. Examples of such conditions include a defined sparsity level (e.g., a defined number or amount of weight values have been removed from the layer) is reached, the change in the output of the layer relative to the original output of the layer is greater than a defined threshold value, etc.

For cases where a quantization technique is used, weight processor 115 iteratively selects a block of weight values from the weight values in the layer of the neural network model and quantizes the weight values in the block of weight values while updating the remaining weight values to minimize the change in the output of the layer. Weight processor 115 iteratively performs this process until a set of conditions are satisfied. Examples of such conditions include no remaining blocks of unquantized weight values, the change in the output of the layer relative to the original output of the layer is greater than a defined threshold value, etc. In some embodiments, weight processor 115 selects a block of weight values from the blocks of weight values in a layer of a neural network model by selecting a block of weight values that cause the least impact on the output of the layer. One of ordinary skill in the art will understand that any number of different quantizing techniques can be used to quantize weight values in a layer of a neural network model.

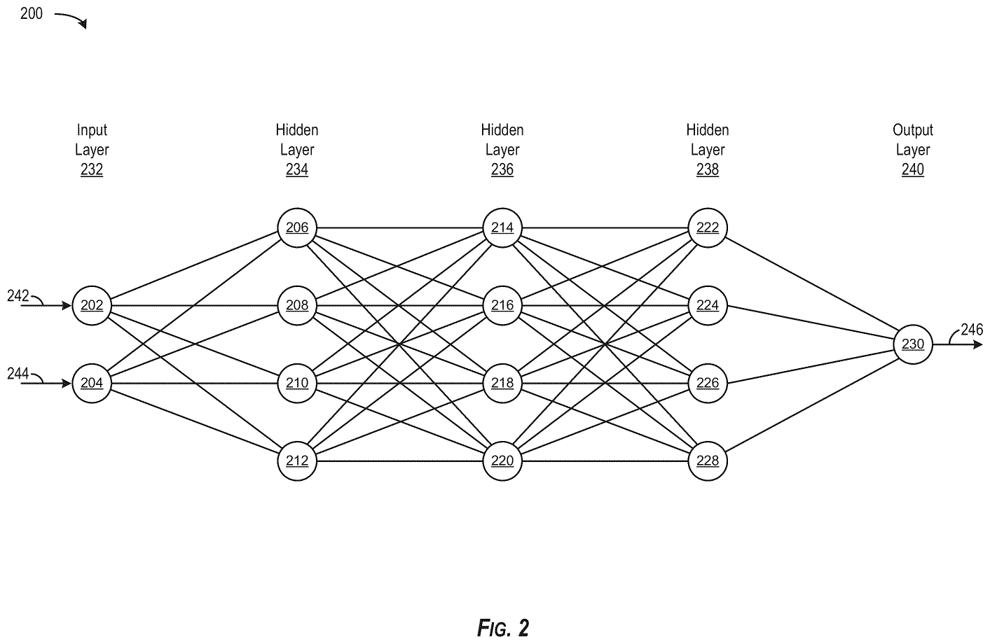

Several examples of optimizing a layer in a neural network will now be described by reference to FIGS. 1-8. FIG. 2 illustrates an example deep neural network (DNN) model 200 according to some embodiments. As depicted, DNN model 200 includes input layer 232, hidden layers 234-238, and output layer 240. For this example, input layer 232 includes nodes 202 and 204, hidden layer 234, hidden layer 236 includes nodes 214-220, hidden layer 238 includes nodes 222-228, and output layer 240 includes node 230. Each connection between a pair of nodes has a weight value associated with it.

Each of the nodes 202 and 204 is configured to receive input data (input data 242 and 244, respectively, in this example) and pass the input data to nodes in hidden layer 234 to which the node 202/204 is connected. Here, node 202 passes input data 242 to nodes 206-212 of hidden layer 234. Similarly, node 204 passes input data 244 to nodes 206-212 of hidden layer 234.

In hidden layer 234, each of the nodes 206-212 receives input data 242 and 244 from nodes 202 and 204, multiplies the input data 242 and 244 with the corresponding weight values associated with the connections, sums the products together, and applies an activation function to the sum to produce an output value. Then, each of the nodes 206-212 sends its output value to the nodes 214-220 in hidden layer 236 with which it is connected.

Similar to nodes 206-212 in hidden layer 234, each of the nodes 214-220 in hidden layer 236 is configured to receive the outputs from nodes 206-212, multiply the outputs with the corresponding weight values associated with the connections, sum the products together, and apply an activation function to the sum to produce an output value. Next, each of the nodes 214-220 sends its output value to the nodes 222-228 in hidden layer 238 with which it is connected.

For hidden layer 238, each of the nodes 222-228 receives the outputs from nodes 214-220, multiplies the outputs with the corresponding weight values associated with the connections, sums the products together, and applies an activation function to the sum to produce an output value. Each of the nodes 222-228 then sends its output value to the node 230 in output layer 240.

Node 230 is configured to receive the outputs from nodes 222-228, multiply the outputs with the corresponding weight values associated with the connections, sum the products together, and apply an activation function to the sum to produce an output value 246, which is the output of DNN model 200.

DNN model 200 can be trained to generate a desired output given a particular input. Before DNN model 200 is trained, the weight values associated with the connections may be initialized (e.g., set to random values, set to predefined values, etc.). Then, sets of training data are used as inputs to input layer 232. Specifically, a set of training data is provided as input to DNN model 200. Based on the set of training data that is propagated through DNN model 200, DNN model 200 generates an output value. The output value is compared to a known result and, based on the comparison, the weight values in DNN model 200 are updated. This process is repeated with different sets of training data until DNN model 200 is able to produce outputs at a defined level of accuracy.

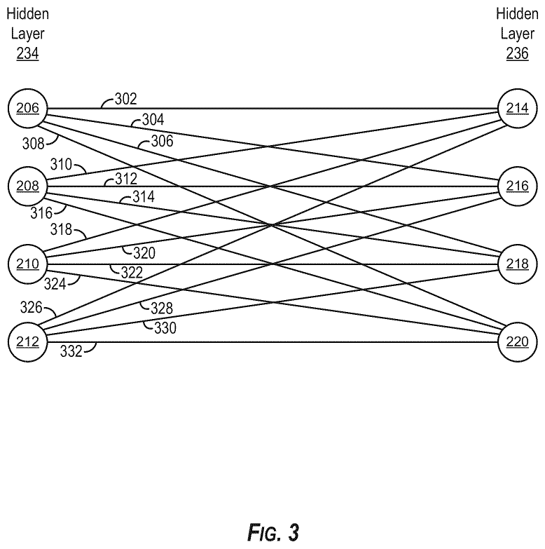

FIG. 3 illustrates the weight values of a layer in DNN model 200 according to some embodiments. In particular, FIG. 3 shows weight values 302-332 of layer 236 in DNN model 200. Weight value 302 is associated with the connection between nodes 206 and 214, weight value 304 is associated with the connection between nodes 206 and 216, weight value 306 is associated with the connection between nodes 206 and 218, weight value 308 is associated with the connection between nodes 206 and 220, weight value 310 is associated with the connection between nodes 208 and 214, weight value 312 is associated with the connection between nodes 208 and 216, weight value 314 is associated with the connection between nodes 208 and 218, weight value 316 is associated with the connection between nodes 208 and 220, weight value 318 is associated with the connection between nodes 210 and 214, weight value 320 is associated with the connection between nodes 210 and 216, weight value 322 is associated with the connection between nodes 210 and 218, weight value 324 is associated with the connection between nodes 210 and 220, weight value 326 is associated with the connection between nodes 212 and 214, weight value 328 is associated with the connection between nodes 212 and 216, weight value 330 is associated with the connection between nodes 212 and 218, and weight value 332 is associated with the connection between nodes 212 and 220.

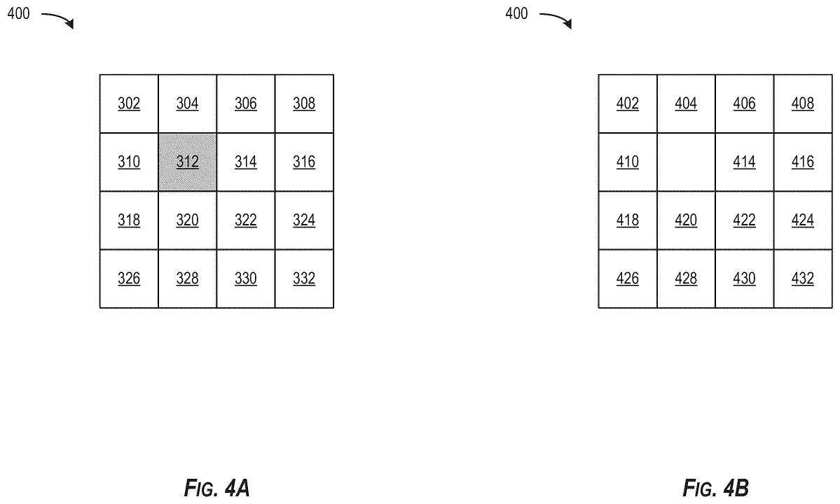

In some embodiments, a neural network model can be implemented by a set of matrices. For example, the weight values of each layer of a neural network model may be represented in a matrix. FIGS. 4A and 4B illustrate an example of sparsifying the weight values illustrated in FIG. 3 according to some embodiments. FIG. 4A illustrates matrix 400 of the weight values in hidden layer 236 shown in FIG. 3. As shown, matrix 400 is a 4×4 matrix. The first row of matrix 400 includes the weight values associated with the connections between node 206 and each of the nodes 214-220, the second row of matrix 400 includes the weight values associated with the connections between node 208 and each of the nodes 214-220, the third row of matrix 400 includes the weight values associated with the connections between node 210 and each of the nodes 214-220, and the fourth row of matrix 400 includes the weight values associated with the connections between node 212 and each of the nodes 214-220.

A first example operation will be described by reference to FIGS. 1-6. The first example demonstrates how a layer of a neural network model is optimized using sparsification. The first example operation begins by neural network model optimizer 105 accessing neural network models storage 120 to retrieve DNN model 200. Next, neural network model optimizer 105 sends DNN model 200 to neural network layer manager 110 for processing. Upon receiving DNN model 200, neural network layer manager 110 neural network layer manager 110 identifies hidden layer 236 in DNN model 200. Neural network layer manager 110 sends weight processor 115 DNN model 200 along with a request to process the weight values in hidden layer 236.

When weight processor 115 receives from neural network layer manager 110 DNN model 200 and the request to process the weight values in hidden layer 236 of DNN model 200, weight processor 115 selects a weight value from the weight values in hidden layer 236 of DNN model 200 by determining a loss value for each weight value in matrix 400 based on equation (1). For this example, weight value 312 produced the lowest loss value, as indicated by a gray highlighting in FIG. 4A. As such, weight processor 115 removes weight value 312 from matrix 400. Then, weight processor 115 uses equation (3) to update the remaining weight values 302-310 and 314-332 in matrix 400 in a way that minimizes the error calculated using equation (4). FIG. 4B illustrates matrix 400 after weight value 312 is removed and the remaining weight values 302-310 and 314-332 are updated. Weight values 402-410 and 414-432 are the updated versions of weight values 302-310 and 314-332, respectively.

In this example, the set of conditions in which weight processor 115 stops processing the weight values in hidden layer 236 is when the sparsity level reaches 50% or the smallest loss value for a weight value calculated using equation (1) is greater than a defined threshold value. After updating the remaining weight values in matrix 400 shown in FIG. 4B, weight processor 115 determines that the set of conditions are not satisfied. Therefore, weight processor 115 continues to process the weight values in hidden layer 236.

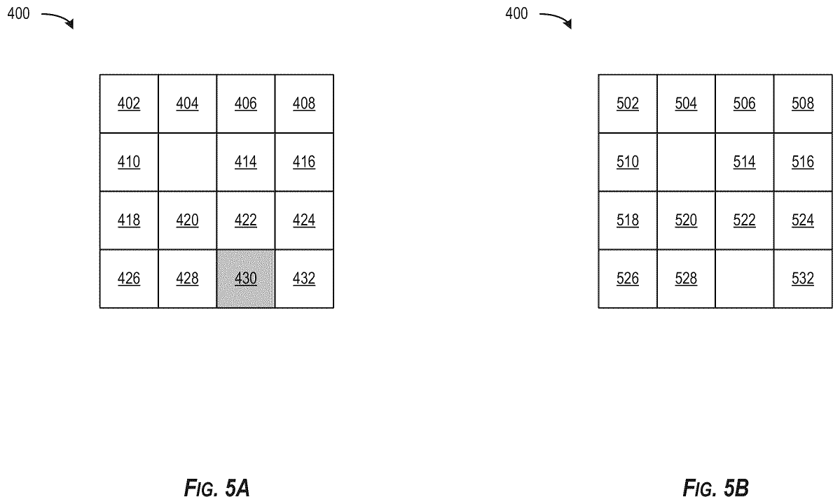

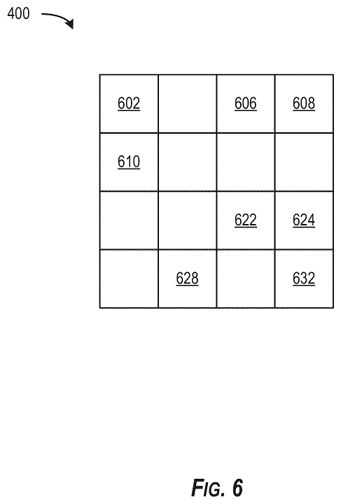

FIGS. 5A and 5B illustrate another example of sparsifying the weight values illustrated in FIG. 3 according to some embodiments. For this example, weight processor 115 selects a weight value from the remaining weight values 402-410 and 414-432 shown in matrix 400 of FIG. 4B by determining a loss value for each weight value in matrix 400 based on equation (1) and selecting weight value that produced the lowest loss value. Here, weight value 430 produced the lowest loss value, as indicated by a gray highlighting in FIG. 5A. Thus, weight processor 115 removes weight value 430 from matrix 400. Weight processor 115 then uses equation (3) to update the remaining weight values 402-410, 414-428, and 432 in matrix 400 in a way that minimizes the error calculated using equation (4). FIG. 5B illustrates matrix 400 after weight value 430 is removed and the remaining weight values 402-410, 414-428, and 432 are updated. Weight values 502-510, 514-528, and 532 are the updated versions of weight values 402-410, 414-428, and 432, respectively.

As explained above, the set of conditions in which weight processor 115 stops processing the weight values in hidden layer 236 is when the level of sparsification reaches 50% or the smallest loss value for a weight value calculated using equation (1) is greater than a defined threshold value. After updating the remaining weight values in matrix 400 depicted in FIG. 5B, weight processor 115 determines that the set of conditions are not satisfied. In this example, weight processor 115 continues to process the weight values in hidden layer 236 until the sparsity level reaches 50%. FIG. 6 illustrates the weight values illustrated in FIG. 3 after sparsification is completed according to some embodiments. As illustrated in FIG. 6, hidden layer 236 has been sparsified to a level of 50% sparsity (i.e., half of the weight values have been removed). The remaining weight values 602, 606-610, 622, 624, 628, and 632 are the remaining weight values for hidden layer 236 of DNN model 200.

After processing hidden layer 236, neural network layer manager 110 may continue processing remaining layers (e.g., hidden layer 238) in DNN model 200 in the same manner as the example described above by reference to FIGS. 2-6. Once neural network layer manager 110 finishes processing DNN model 200, neural network layer manager 110 stores DNN model 200 in optimized neural network models storage 125.

A second example operation will now be described by reference to FIGS. 1-3, 7A-7D, and 8. The second operation demonstrates how a layer of a neural network model is optimized using quantization. The second example operation starts in the same way as the first example: neural network model optimizer 105 accesses neural network models storage 120 to retrieve DNN model 200 and then sends DNN model 200 to neural network layer manager 110 for processing. In response, neural network layer manager 110 neural network layer manager 110 identifies hidden layer 236 in DNN model 200 and then sends weight processor 115 DNN model 200 and a request to process the weight values in hidden layer 236.

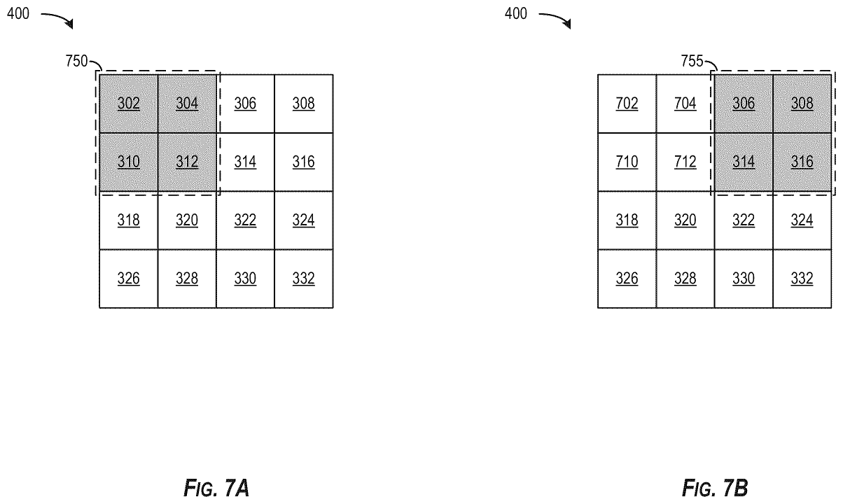

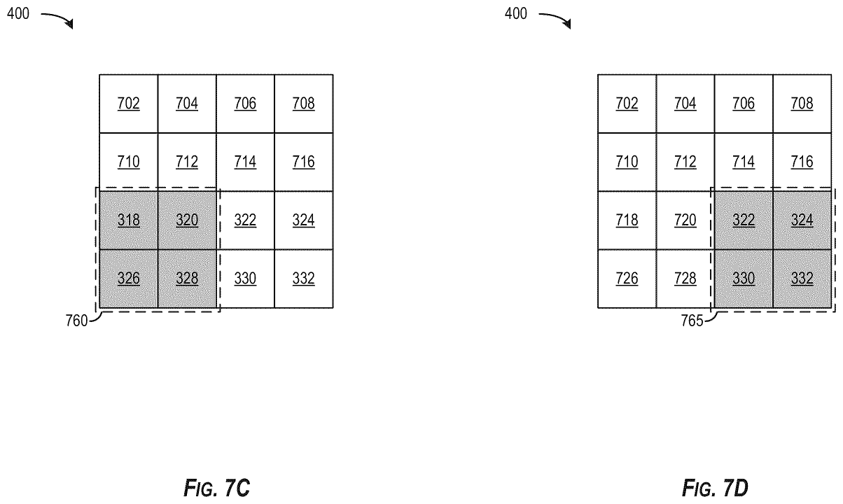

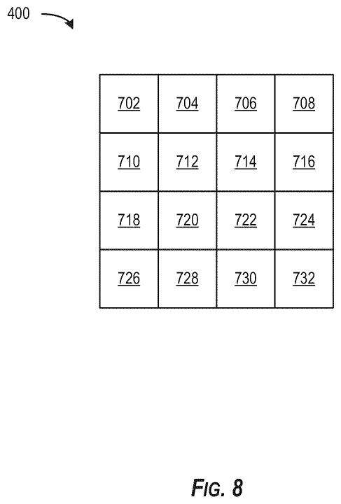

Upon receiving DNN model 200 and the request from neural network layer manager 110, weight processor 115 selects a block of weight values from the weight values in hidden layer 236 of DNN model 200. FIG. 7A illustrates the selected block of weight values for this example. As illustrated, weight processor 115 has selected block 750 of weight values 302, 304, 310, and 312. Next, weight processor 115 quantizes weight values 302, 304, 310, and 312 in block 750. FIG. 7B illustrates matrix 400 after the weight values in block 750 are quantized. As depicted in FIG. 7B, weight values 702, 704, 710, and 712 are the quantized versions of weight values 302, 304, 310, and 312, respectively.

In this example, the set of conditions in which weight processor 115 stops processing blocks of weight values in hidden layer 236 is when all blocks of weight values have been quantized. Since there are still blocks of weight values left to quantize, weight processor 115 continues to process blocks of weight values in hidden layer 236. Hence, weight processor 115 selects another block of weight values. FIG. 7B also shows the second selected block of weight values for this example. As depicted, weight processor 115 has selected block 755 of weight values 306, 308, 314, and 316. Weight processor 115 then quantizes weight values 306, 308, 314, and 316 in block 755. FIG. 7C illustrates matrix 400 after the weight values in block 755 are quantized. As shown, weight values 706, 708, 714, and 716 are the quantized versions of weight values 306, 308, 314, and 316, respectively.

After quantizing block 750, weight processor 115 continues to process blocks of weight values in hidden layer 236 by selecting another block of weight values. FIG. 7C also illustrates the third selected block of weight values for this example. As shown, weight processor 115 has selected block 760 of weight values 318, 320, 326, and 328. Next, weight processor 115 quantizes weight values 318, 320, 326, and 328 in block 760. FIG. 7D illustrates matrix 400 after the weight values in block 760 are quantized. As depicted in FIG. 7D, weight values 718, 720, 726, and 728 are the quantized versions of weight values 318, 320, 326, and 328, respectively.

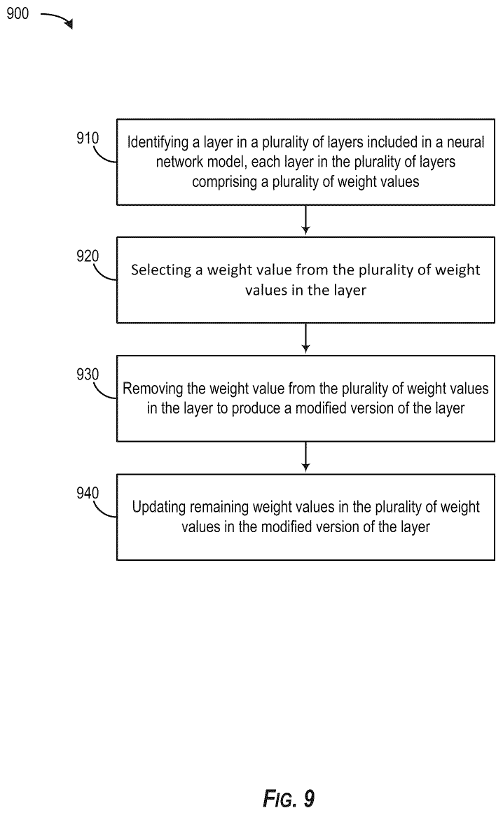

Weight processor 115 continues to process blocks of weight values in hidden layer 236 by selecting another block of weight values. FIG. 7D also illustrates the fourth selected block of weight values for this example. As illustrated, weight processor 115 has selected block 765 weight values 322, 324, 330, and 332. Then, weight processor 115 quantizes weight values 322, 324, 330, and 332 in block 765. FIG. 8 illustrates matrix 400 after the weight values in block 765 are quantized. As shown, weight values 722, 724, 730, and 732 are the quantized versions of weight values 322, 324, 330, and 332, respectively. As there are no more blocks of weight values to quantize, weight processor 115 has finished processing the weight values in hidden layer 236 of DNN model 200.

Once weight processor 115 finishes processing hidden layer 236, neural network layer manager 110 may continue processing remaining layers (e.g., hidden layer 238) in DNN model 200 in the same manner as the example described above by reference to FIGS. 1-3, 7A-7D, and 8. After completing the processing of DNN model 200, neural network layer manager 110 stores DNN model 200 in optimized neural network models storage 125.

The second example operation described above by reference to FIGS. 1-3, 7A-7D, and 8 show how weight processor 115 selects blocks of weight values and quantizes them. One of ordinary skill in the art will appreciate that, in different embodiments, the blocks of weight values may be different and/or have a different number of weight values. For example, weight processor 115 can select rows of weight values, columns of weight values, etc. in some embodiments.

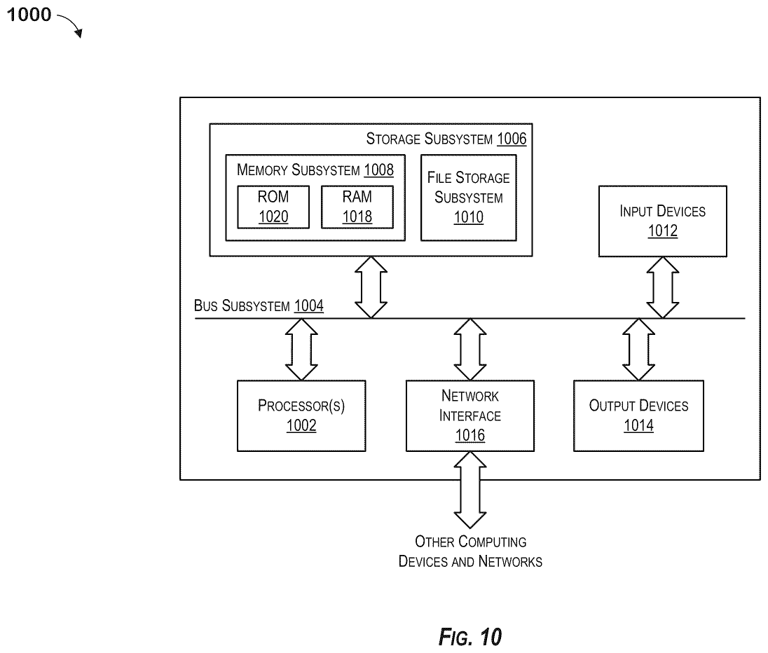

FIG. 9 illustrates a process 900 for optimizing a deep neural network model based on sparsification according to some embodiments. In some embodiments, neural network model optimizer 105 performs process 900. Process 900 begins by identifying, at 910, a layer in a plurality of layers included in a neural network model, each layer in the plurality of layers comprising a plurality of weight values. Referring to FIGS. 1-3 as an example, neural network layer manager 110 can identify hidden layer 236 in DNN model 200.

Next, process 900 selects, at 920, a weight value from the plurality of weight values in the layer. Referring to FIGS. 1-4A as an example, weight processor 115 may select weight value 312 from the weight values 302-332. At 930, process 900 removes the weight value from the plurality of weight values in the layer to produce a modified version of the layer. Referring to FIGS. 1-4B as an example, weight processor 115 can remove weight value 312 from matrix 400.

Finally, process 900 updates, at 940, remaining weight values in the plurality of weight values in the modified layer. Removing the weight value and updating the remaining weight values provides greater compression of the neural network model and reduces loss of accuracy of the neural network model. Referring to FIGS. 1-4B as an example, weight processor 115 may update the remaining weight values 302-310, and 314-332. FIG. 4B shows weight values 402-410 and 414-432 as being the updated versions of weight values 302-310 and 314-332, respectively.

The examples and embodiments described above by reference to FIGS. 1-9 explain how neural network models can be optimized by sparsifying and/or quantizing weights in layers of the neural network models. One of ordinary skill in the art will appreciate that the same techniques may be applied to other defined operations in neural network models. Specifically, these approaches can be applied to minimize the output changes caused by quantization and/or sparsification in any operation, such as activations for example. By quantizing and/or removing the weight(s) or activation(s) that cause the least impact on the output, the remaining weights are updated to minimize the deviation from the original output. This iterative process continues until a specific set of conditions are satisfied. In some embodiments, directly measuring the output changes or using a first or higher order Taylor expansions can be used to identify the weight(s) or activation(s) that induce the minimal change. Additionally, the techniques may be applied in a multiple layer or multiple block manner, in some embodiments.

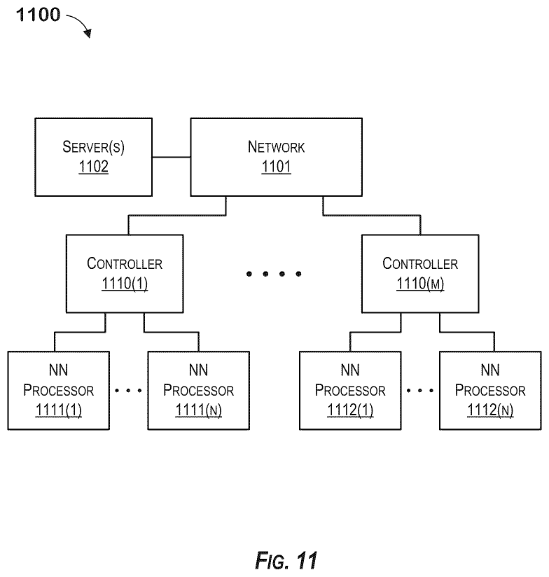

FIG. 10 depicts a simplified block diagram of an example computer system 1000, which can be used to implement the techniques described in the foregoing disclosure. For example, computer system 1000 may be used to implement system 100. As shown in FIG. 10, computer system 1000 includes one or more processors 1002 that communicate with a number of peripheral devices via a bus subsystem 1004. These peripheral devices may include a storage subsystem 1006 (e.g., comprising a memory subsystem 1008 and a file storage subsystem 1010) and a network interface subsystem 1016. Some computer systems may further include user interface input devices 1012 and/or user interface output devices 1014.

Bus subsystem 1004 can provide a mechanism for letting the various components and subsystems of computer system 1000 communicate with each other as intended. Although bus subsystem 1004 is shown schematically as a single bus, alternative embodiments of the bus subsystem can utilize multiple busses.

Network interface subsystem 1016 can serve as an interface for communicating data between computer system 1000 and other computer systems or networks. Embodiments of network interface subsystem 1016 can include, e.g., Ethernet, a Wi-Fi and/or cellular adapter, a modem (telephone, satellite, cable, ISDN, etc.), digital subscriber line (DSL) units, and/or the like.

Storage subsystem 1006 includes a memory subsystem 1008 and a file/disk storage subsystem 1010. Subsystems 1008 and 1010 as well as other memories described herein are examples of non-transitory computer-readable storage media that can store executable program code and/or data that provide the functionality of embodiments of the present disclosure.

Memory subsystem 1008 includes a number of memories including a main random access memory (RAM) 1018 for storage of instructions and data during program execution and a read-only memory (ROM) 1020 in which fixed instructions are stored. File storage subsystem 1010 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1000 is illustrative and many other configurations having more or fewer components than system 1000 are possible.

FIG. 11 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 1102, which may comprise architectures illustrated in FIG. 10 above, may be coupled to a plurality of controllers 1110(1)-1110(M) over a communication network 1101 (e.g., switches, routers, etc.). Controllers 1110(1)-1110(M) may also comprise architectures illustrated in FIG. 10 above. Each controller 1110(1)-1110(M) may be coupled to one or more NN processors, such as processors 1111(1)-1111(N) and 1112(1)-1112(N), for example. NN processors 1111(1)-1111(N) and 1112(1)-1112(N) may include a variety of configurations of functional processing blocks and memory optimized for neural network processing, such as training or inference. The NN processors are optimized for neural network computations. Server 1102 may configure controllers 1110 with NN models as well as input data to the models, which may be loaded and executed by NN processors 1111(1)-1111(N) and 1112(1)-1112(N) in parallel, for example. Models may include layers and associated weight values as described above, for example. NN processors may load the models and apply the inputs to produce output results. NN processors may also implement training algorithms described herein, for example.

### Further Example Embodiments

In various embodiments, the present disclosure includes systems, methods, and apparatuses for optimizing deep neural network models based on sparsification and quantization. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in some embodiments, the techniques described herein relate to a method including: identifying a layer in a plurality of layers included in a neural network model, each layer in the plurality of layers including a plurality of weight values; selecting a weight value from the plurality of weight values in the layer; removing the weight value from the plurality of weight values in the layer to produce a modified version of the layer; and updating remaining weight values in the plurality of weight values in the modified version of the layer, wherein removing the weight value and updating the remaining weight values provides greater compression of the neural network model and reduces loss of accuracy of the neural network model.

In some embodiments, the techniques described herein relate to a method, wherein the layer in the plurality of layers is a first layer in the plurality of layers, wherein selecting the weight value from the plurality of weight values is based on a plurality of outputs generated from a second layer in the plurality of layers, wherein the second layer in the plurality of layers is a previous adjacent layer with respect to the first layer.

In some embodiments, the techniques described herein relate to a method, wherein selecting the weight value in the plurality of weight values is based on a Hessian of the plurality of outputs generated from the second layer in the plurality of layers.

In some embodiments, the techniques described herein relate to a method, wherein selecting the weight value in the plurality of weight values is further based on a gradient associated with the first layer.

In some embodiments, the techniques described herein relate to a method, wherein, updating the remaining weight values in the plurality of weight values in the modified version of the layer includes modifying the remaining weight values in the plurality of weight values in a manner that minimizes an error between (1) the modified version of the layer and a plurality of outputs generated from a second layer in the plurality of layers and (2) an unmodified version of the layer and the plurality of outputs generated from the second layer in the plurality of layers.

In some embodiments, the techniques described herein relate to a method further including repeatedly selecting a particular weight value from the plurality of weight values, removing the particular weight value from the plurality of weight values of the layer to produce a particular modified version of the layer, and, updating particular remaining weight values in the plurality of weight values in the particular modified version of the layer until a defined sparsity level is reached.

In some embodiments, the techniques described herein relate to a method, wherein the layer is a first layer, wherein the weight value is a first weight value, the method further including: identifying a second layer in the plurality of layers included in the neural network model; selecting a second weight value from the plurality of weight values in the second layer; removing the second weight value from the plurality of weight values in the second layer to produce a modified version of the second layer; and updating remaining weight values in the plurality of weight values in the modified version of the second layer.

In some embodiments, the techniques described herein relate to a non-transitory machine-readable medium storing a program executable by at least one processing unit of a device, the program including sets of instructions for: identifying a layer in a plurality of layers included in a neural network model, each layer in the plurality of layers including a plurality of weight values; selecting a weight value from the plurality of weight values in the layer; removing the weight value from the plurality of weight values in the layer to produce a modified version of the layer; and updating remaining weight values in the plurality of weight values in the modified version of the layer, wherein removing the weight value and updating the remaining weight values provides greater compression of the neural network model and reduces loss of accuracy of the neural network model.

In some embodiments, the techniques described herein relate to a non-transitory machine-readable medium, wherein the layer in the plurality of layers is a first layer in the plurality of layers, wherein selecting the weight value from the plurality of weight values is based on a plurality of outputs generated from a second layer in the plurality of layers, wherein the second layer in the plurality of layers is a previous adjacent layer with respect to the first layer.

In some embodiments, the techniques described herein relate to a non-transitory machine-readable medium, wherein selecting the weight value in the plurality of weight values is based on a Hessian of the plurality of outputs generated from the second layer in the plurality of layers.

In some embodiments, the techniques described herein relate to a non-transitory machine-readable medium, wherein selecting the weight value in the plurality of weight values is further based on a gradient associated with the first layer.

In some embodiments, the techniques described herein relate to a non-transitory machine-readable medium, wherein, updating the remaining weight values in the plurality of weight values in the modified version of the layer includes modifying the remaining weight values in the plurality of weight values in a manner that minimizes an error between (1) the modified version of the layer and a plurality of outputs generated from a second layer in the plurality of layers and (2) an unmodified version of the layer and the plurality of outputs generated from the second layer in the plurality of layers.

In some embodiments, the techniques described herein relate to a non-transitory machine-readable medium, wherein the program further includes a set of instructions for repeatedly selecting a particular weight value from the plurality of weight values, removing the particular weight value from the plurality of weight values of the layer to produce a particular modified version of the layer, and, updating particular remaining weight values in the plurality of weight values in the particular modified version of the layer until a defined sparsity level is reached.

In some embodiments, the techniques described herein relate to a non-transitory machine-readable medium, wherein the layer is a first layer, wherein the weight value is a first weight value, wherein the program further includes a set of instructions for: identifying a second layer in the plurality of layers included in the neural network model; selecting a second weight value from the plurality of weight values in the second layer; removing the second weight value from the plurality of weight values in the second layer to produce a modified version of the second layer; and updating remaining weight values in the plurality of weight values in the modified version of the second layer.

In some embodiments, the techniques described herein relate to a system including: a set of processing units; and a non-transitory machine-readable medium storing instructions that when executed by at least one processing unit in the set of processing units cause the at least one processing unit to: identify a layer in a plurality of layers included in a neural network model, each layer in the plurality of layers comprising a plurality of weight values; select a weight value from the plurality of weight values in the layer; remove the weight value from the plurality of weight values in the layer to produce a modified version of the layer; and update remaining weight values in the plurality of weight values in the modified version of the layer, wherein removing the weight value and updating the remaining weight values provides greater compression of the neural network model and reduces loss of accuracy of the neural network model.

In some embodiments, the techniques described herein relate to a system, wherein the layer in the plurality of layers is a first layer in the plurality of layers, wherein selecting the weight value from the plurality of weight values is based on a plurality of outputs generated from a second layer in the plurality of layers, wherein the second layer in the plurality of layers is a previous adjacent layer with respect to the first layer.

In some embodiments, the techniques described herein relate to a system, wherein selecting the weight value in the plurality of weight values is based on a Hessian of the plurality of outputs generated from the second layer in the plurality of layers.

In some embodiments, the techniques described herein relate to a system, wherein selecting the weight value in the plurality of weight values is further based on a gradient associated with the first layer.

In some embodiments, the techniques described herein relate to a system, wherein, updating the remaining weight values in the plurality of weight values in the modified version of the layer includes modifying the remaining weight values in the plurality of weight values in a manner that minimizes an error between (1) the modified version of the layer and a plurality of outputs generated from a second layer in the plurality of layers and (2) an unmodified version of the layer and the plurality of outputs generated from the second layer in the plurality of layers.

In some embodiments, the techniques described herein relate to a system, wherein the instructions further cause the at least one processing unit to repeatedly selecting a particular weight value from the plurality of weight values, removing the particular weight value from the plurality of weight values of the layer to produce a particular modified version of the layer, and, updating particular remaining weight values in the plurality of weight values in the particular modified version of the layer until a defined sparsity level is reached.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method comprising:
identifying a layer in a plurality of layers included in a neural network model, each layer in the plurality of layers comprising a plurality of weight values;
selecting a weight value from the plurality of weight values in the layer;
removing the weight value from the plurality of weight values in the layer to produce a modified version of the layer; and
updating remaining weight values in the plurality of weight values in the modified version of the layer,
wherein removing the weight value and updating the remaining weight values provides greater compression of the neural network model and reduces loss of accuracy of the neural network model.

2. The method of claim 1, wherein the layer in the plurality of layers is a first layer in the plurality of layers, wherein selecting the weight value from the plurality of weight values is based on a plurality of outputs generated from a second layer in the plurality of layers, wherein the second layer in the plurality of layers is a previous adjacent layer with respect to the first layer.

3. The method of claim 2, wherein selecting the weight value in the plurality of weight values is based on a Hessian of the plurality of outputs generated from the second layer in the plurality of layers.

4. The method of claim 3, wherein selecting the weight value in the plurality of weight values is further based on a gradient associated with the first layer.

5. The method of claim 1, wherein, updating the remaining weight values in the plurality of weight values in the modified version of the layer comprises modifying the remaining weight values in the plurality of weight values in a manner that minimizes an error between (1) the modified version of the layer and a plurality of outputs generated from a second layer in the plurality of layers and (2) an unmodified version of the layer and the plurality of outputs generated from the second layer in the plurality of layers.

6. The method of claim 1 further comprising repeatedly selecting a particular weight value from the plurality of weight values, removing the particular weight value from the plurality of weight values of the layer to produce a particular modified version of the layer, and, updating particular remaining weight values in the plurality of weight values in the particular modified version of the layer until a defined sparsity level is reached.

7. The method of claim 1, wherein the layer is a first layer, wherein the weight value is a first weight value, the method further comprising:
identifying a second layer in the plurality of layers included in the neural network model;
selecting a second weight value from the plurality of weight values in the second layer;
removing the second weight value from the plurality of weight values in the second layer to produce a modified version of the second layer; and
updating remaining weight values in the plurality of weight values in the modified version of the second layer.

8. A non-transitory machine-readable medium storing a program executable by at least one processing unit of a device, the program comprising sets of instructions for:
identifying a layer in a plurality of layers included in a neural network model, each layer in the plurality of layers comprising a plurality of weight values;
selecting a weight value from the plurality of weight values in the layer;
removing the weight value from the plurality of weight values in the layer to produce a modified version of the layer; and
updating remaining weight values in the plurality of weight values in the modified version of the layer,
wherein removing the weight value and updating the remaining weight values provides greater compression of the neural network model and reduces loss of accuracy of the neural network model.

9. The non-transitory machine-readable medium of claim 8, wherein the layer in the plurality of layers is a first layer in the plurality of layers, wherein selecting the weight value from the plurality of weight values is based on a plurality of outputs generated from a second layer in the plurality of layers, wherein the second layer in the plurality of layers is a previous adjacent layer with respect to the first layer.

10. The non-transitory machine-readable medium of claim 9, wherein selecting the weight value in the plurality of weight values is based on a Hessian of the plurality of outputs generated from the second layer in the plurality of layers.

11. The non-transitory machine-readable medium of claim 10, wherein selecting the weight value in the plurality of weight values is further based on a gradient associated with the first layer.

12. The non-transitory machine-readable medium of claim 8, wherein, updating the remaining weight values in the plurality of weight values in the modified version of the layer comprises modifying the remaining weight values in the plurality of weight values in a manner that minimizes an error between (1) the modified version of the layer and a plurality of outputs generated from a second layer in the plurality of layers and (2) an unmodified version of the layer and the plurality of outputs generated from the second layer in the plurality of layers.

13. The non-transitory machine-readable medium of claim 8, wherein the program further comprises a set of instructions for repeatedly selecting a particular weight value from the plurality of weight values, removing the particular weight value from the plurality of weight values of the layer to produce a particular modified version of the layer, and, updating particular remaining weight values in the plurality of weight values in the particular modified version of the layer until a defined sparsity level is reached.

14. The non-transitory machine-readable medium of claim 8, wherein the layer is a first layer, wherein the weight value is a first weight value, wherein the program further comprises a set of instructions for:
identifying a second layer in the plurality of layers included in the neural network model;
selecting a second weight value from the plurality of weight values in the second layer;
removing the second weight value from the plurality of weight values in the second layer to produce a modified version of the second layer; and
updating remaining weight values in the plurality of weight values in the modified version of the second layer.

15. A system comprising:
a set of processing units; and
a non-transitory machine-readable medium storing instructions that when executed by at least one processing unit in the set of processing units cause the at least one processing unit to:
identify a layer in a plurality of layers included in a neural network model, each layer in the plurality of layers comprising a plurality of weight values;
select a weight value from the plurality of weight values in the layer;
remove the weight value from the plurality of weight values in the layer to produce a modified version of the layer; and
update remaining weight values in the plurality of weight values in the modified version of the layer,
wherein removing the weight value and updating the remaining weight values provides greater compression of the neural network model and reduces loss of accuracy of the neural network model.

16. The system of claim 15, wherein the layer in the plurality of layers is a first layer in the plurality of layers, wherein selecting the weight value from the plurality of weight values is based on a plurality of outputs generated from a second layer in the plurality of layers, wherein the second layer in the plurality of layers is a previous adjacent layer with respect to the first layer.

17. The system of claim 16, wherein selecting the weight value in the plurality of weight values is based on a Hessian of the plurality of outputs generated from the second layer in the plurality of layers.

18. The system of claim 17, wherein selecting the weight value in the plurality of weight values is further based on a gradient associated with the first layer.

19. The system of claim 15, wherein, updating the remaining weight values in the plurality of weight values in the modified version of the layer comprises modifying the remaining weight values in the plurality of weight values in a manner that minimizes an error between (1) the modified version of the layer and a plurality of outputs generated from a second layer in the plurality of layers and (2) an unmodified version of the layer and the plurality of outputs generated from the second layer in the plurality of layers.

20. The system of claim 15, wherein the instructions further cause the at least one processing unit to repeatedly selecting a particular weight value from the plurality of weight values, removing the particular weight value from the plurality of weight values of the layer to produce a particular modified version of the layer, and, updating particular remaining weight values in the plurality of weight values in the particular modified version of the layer until a defined sparsity level is reached.
